(19) United States
(12) Patent Application Publication
(10) Pub. No.: US 2012/0137372 A1
(43) Pub. Date: May 31, 2012

(54) APPARATUS AND METHOD FOR PROTECTING CONFIDENTIAL INFORMATION OF MOBILE TERMINAL

(75) Inventors: Soo Jung Shin, Seoul (KR); Hyo Sun Yoo, Seongnam (KR); Do Sung Ahn, Seongnam (KR)

(73) Assignee: INFOSEC CO., LTD., Seoul (KR)

(21) Appl. No.: 13/250,181

(22) Filed: Sep. 30, 2011

(30) Foreign Application Priority Data
Nov. 29, 2010 (KR) 2010-0119405
Nov. 29, 2010 (KR) 2010-0119406

(51) Int. Cl. G06F 12/14

(52) U.S. Cl. 726/26

(57) ABSTRACT

Disclosed herein is an apparatus for protecting the confidential information of a mobile terminal. The apparatus for protecting the confidential information of a mobile terminal includes a storage unit and a confidential information management unit. The storage unit stores at least one piece of confidential information which requires security. The confidential information management unit moves the confidential information from the preset unsecured initial storage area of the storage unit, to the preset secured storage area of the storage unit and stores the confidential data in the preset secured storage area, in order to protect the confidential data, and exclusively manages the secured storage area. The secured storage area is set by the confidential information management unit.

### CROSS-REFERENCE TO RELATED APPLICATION

This application claims under 35 U.S.C. §119(a) the benefit of Korean Application Nos. 10-2010-0119405 filed Nov. 29, 2010 and 10-2010-0119406 filed Nov. 29, 2010, the entire contents of which applications are incorporated herein by reference.

### BACKGROUND OF THE INVENTION

1. Field of the Invention

The present invention relates generally to protection of the confidential information of a mobile terminal, and, more particularly, to an apparatus and method for protecting the confidential information of a mobile terminal, which encrypts confidential information to be stored in a mobile terminal, moves the encrypted confidential information from an initial storage area, in which data is stored, to a secured storage area, in which data is hidden, and stores the encrypted confidential information in the secured storage area, so that the confidential information can be protected, thereby improving security.

2. Description of the Related Art

Generally, mobile terminals, such as mobile phones, can be used to store and manage personal information using a phone book function, a notepad function and an electronic notepad function as well as can be used to perform a voice call function and a message transmission/reception function.

Further, such a mobile terminal can store a call log, generated due to a voice call, and one or more transmitted and received messages, stored due to message transmission/reception. Recently, functions of storing and using information about the card of a user and a certificate in a mobile terminal have been added.

As described above, with the development of mobile communication technology and terminal development technology, confidential information, which is stored in a mobile terminal and requires security, has increased.

However, since such confidential information is stored in a storage space determined for each piece of confidential information in a mobile terminal of the related art, the confidential information stored in a mobile terminal may be illegally used by an unauthorized person when the mobile terminal is hacked or illegally copied.

That is, since confidential information about a user may be used by an unauthorized person through hacking or illegal copying, the user may be socially or economically damaged due to the illegal use of the corresponding confidential information.

Accordingly, there is a need for an apparatus and method capable of preventing confidential information stored in a mobile terminal from being illegally used.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Accordingly, the present invention has been made keeping in mind the above problems occurring in the prior art, and an object of the present invention is to provide an apparatus and method for protecting the confidential information of a mobile terminal, in which a module for exclusively managing a plurality of pieces of confidential information encrypts corresponding confidential information, moves the confidential information to a secured storage area in which data is hidden, stores the confidential information in the secured storage area, and decrypts the confidential information stored in the secured storage area and provides the decrypted confidential information to a user if necessary, so that the confidential information is protected while security for the confidential information is improved, thereby preventing the confidential information from being illegally used through hacking or illegal copying.

Another object of the present invention is to provide an apparatus and method for protecting the confidential information of a mobile terminal, in which a module for exclusively managing a plurality of pieces of confidential information sets a secured storage area, thereby improving stability for the secured storage area.

Further another object of the present invention is to provide an apparatus and method for protecting the confidential information of a mobile terminal, in which a module for exclusively managing a plurality of pieces of confidential information provides a single certificate to at least one of multiple applications that can request the single certificate, so that the multiple applications can share the single certificate, thereby preventing inconvenience which may occur when a plurality of certificates are managed.

In order to accomplish the above objects, an apparatus for protecting the confidential information of a mobile terminal according to an embodiment of the present invention includes a storage unit for storing at least one piece of confidential information which requires security; and a confidential information management unit for moving the confidential information from the preset initial unsecured storage area of the storage unit to the preset secured storage area of the storage unit, in which stored data is hidden, storing the confidential data in the preset secured storage area, in order to protect the confidential data, and exclusively managing the secured storage area. The secured storage area is set by the confidential information management unit.

The confidential information management unit may set a part of a memory area, in which the confidential information management unit is executed, as the secured storage area, may set a part of the storage area of a smart card, which includes a Universal Subscriber Identity Module (USIM) card, or a part of the storage area of an external database, which is in conjunction with the mobile terminal, as the secured storage area, and may set a preset virtual storage space as the secured storage area.

The confidential information management unit may determine confidential information corresponding to each of a plurality of preset security levels, and, when any one of the security levels is selected from among the plurality of security levels, may move the confidential information corresponding to the selected security level to the secured storage area, and may store the corresponding confidential information in the secured storage.

The confidential information management unit may generate dummy data and store the dummy data in the initial storage area after moving the confidential information to the secured storage area.

The confidential information management unit may restore the confidential information stored in the secured storage area to the initial storage area in response to a user request.

The confidential information management unit may include a preset reliable application list, and, when an application which requested the confidential information is an application included in the reliable application list, may provide the confidential information to the application which requested the confidential information.

A method for protecting the confidential information of a mobile terminal according to an embodiment of the present invention includes setting a secured storage area in which stored data is hidden; moving the confidential information from a preset initial unsecured storage area to the set secured storage area and storing the confidential information in the set secured storage area in order to protect at least one piece of confidential information which requires security; and when the confidential information is requested, accessing the secured storage area and providing the confidential information through exclusive management of the secured storage area.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating the configuration of an apparatus for protecting the confidential information of a mobile terminal according to an embodiment of the present invention;

FIG. 2 is a view illustrating the configuration of a confidential information management module of FIG. 1 according to the embodiment;

FIG. 3 is a view illustrating the hierarchy structure of the confidential information management module of FIG. 1;

FIG. 4 is a flowchart illustrating a method for protecting the confidential information of a mobile terminal according to an embodiment of the present invention;

FIG. 5 is a flowchart illustrating an example added to the present invention of FIG. 4; and

FIG. 6 is a flowchart illustrating a process of sharing a single certificate included in the confidential information of a mobile terminal according to the present invention.

### DESCRIPTION OF THE PREFERRED EMBODIMENTS

Preferred embodiments of the present invention will be described in detail with reference to the attached drawings. In the description, when it is determined that detailed descriptions of related well-known configurations or functions would make the gist of the present invention obscure, they will be omitted.

However, the present invention is not restricted or limited to the embodiments. The same reference numerals used throughout the drawings designate the same components.

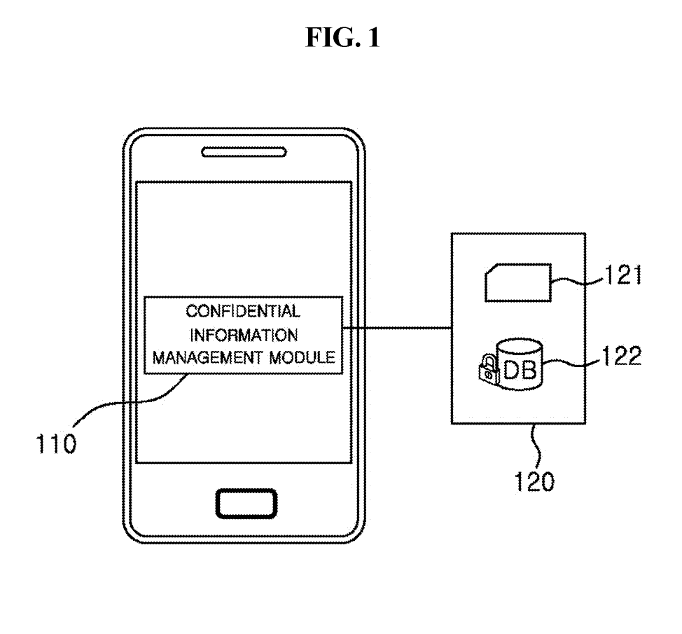

An apparatus and method for protecting the confidential information of a mobile terminal according to embodiments of the present invention will be described in detail with reference to FIGS. 1 to 6.

FIG. 1 is a view illustrating the configuration of an apparatus for protecting the confidential information of a mobile terminal according to an embodiment of the present invention.

Referring to FIG. 1, a confidential information protection apparatus includes a confidential information management module 110 and a storage unit 120.

The storage unit 120 is an element in which confidential information according to the present invention is stored, may include a general storage area section 121 corresponding to a storage area in which stored data is open, that is, can be viewed from the outside, and a secured storage area section 122 corresponding to a storage area in which stored data is hidden in order to improve security. The general storage area section 121 and the secured storage area section 122 may be formed by single storage means and may be respectively formed by separate storage means.

Here, the confidential information is information which can be stored in a mobile terminal and requires security, and the conception thereof includes personal confidential information and information about execution of security. The personal confidential information includes a phone book, an address book, a call log, a transmitted or received message, a photo, a video, a certificate (including an official certificate, a private certificate, or a single certificate), and information about a card (including information about a credit card and information about a point card). The information about execution of security may include at least one piece of information about authentication and a key value, such as a public key or a private key, used to access at least a part of the confidential information. The confidential information may further include information which was determined or selected by a user depending on a situation.

The storage unit 120 is storage means which may include the general storage area section 121 and the secured storage area section 122, and may include a smart card including a Universal Subscriber Identity Module (USIM), memory provided in a mobile terminal, a preset virtual storage space, and external storage means with which can be in conjunction via a network, for example, a universal DataBase (DB) provided in a specific server.

That is, the storage unit 120 may divide any one of memory in a mobile terminal, a virtual storage space, a smart card and an external database into the general storage area section 121 and the secured storage area section 122. That is, the storage unit 120 may form any one storage area of memory in a mobile terminal, a virtual storage space, a smart card and an external database as the general storage area section 121, and form another storage area as the secured storage area section 122.

Here, the secured storage area section 122 of the storage unit 120 may be set by a confidential information management module 110 for exclusively managing the secured storage area.

Hereinafter the general storage area section 121 and the secured storage area section 122, which are included in the storage unit 120, will be referred to as a general storage area and a secured storage area, respectively, in the present invention.

The confidential information management module 110 is a module for encrypting various types of confidential information which can be stored in a mobile terminal and storing the encrypted confidential information in the secured storage area, thereby performing a process of protecting the confidential information, that is, a module for exclusively managing access to the secured storage area and the confidential information stored in the secured storage area.

Here, when confidential information stored in the secured storage area is requested by a user or by performing a specific function, the confidential information management module 110 can detect the request, exclusively access the secured storage area, decrypt encrypted confidential information, and then provide the confidential information.

The confidential information management module 110 can set the secured storage area. For example, the confidential information management module 110 can set a part of a memory area assigned to the confidential information management module 110 as the secured storage area, and can set a part of the storage area of a smart card to the secured storage area when the smart card including a USIM card is provided, can set a part of the storage area of an external database which is in conjunction with the mobile terminal as the secured storage area, and can set a preset virtual storage space as the secured storage area. That is, when the confidential information management module 110 is driven using software, a part of a memory area in which the corresponding software is run can be previously set as the secured storage area.

The confidential information management module 110 assesses the security vulnerability of the mobile terminal. If security status is determined to be stable (or reliable), the confidential information management module 110 stores confidential information in the secured storage area or provides the confidential information stored in the secured storage area.

Here, the confidential information management module 110 can determine the security vulnerability of the mobile terminal based on the combination of the attribute of an application, which stores or requests the confidential information, with the security attribute of the mobile terminal itself. The security attribute of the mobile terminal may include manager (root) right permission status, mobile terminal locking status, and unauthorized application installation status.

It is preferable that the confidential information management module 110 perform a user authentication procedure depending on a situation in order to prevent the secured storage area from being accessed by an unauthorized person.

Various methods may be applied to user authentication. For example, the user authentication procedure can be performed using a method of comparing a preset user password with a user password directly received from a mobile terminal user. As another example, the user authentication procedure can be performed using the dedicated password of the confidential information management module 110 provided in the mobile terminal.

Further, when a plurality of preset security levels can be set to, for example, a high level, a medium level and a low level, the confidential information management module 110 can determine confidential information corresponding to each of the security levels. When any one of the plurality of security levels is selected, at least one piece of confidential information corresponding to the selected security level can be encrypted and then stored in the secured storage area.

For example, assuming that the confidential information includes a phone book, a transmitted or received message, a certificate, information about a card, a photo, and information about execution of security (for example, information about authentication or key values) used to access the confidential information, all the pieces of confidential information is encrypted and then stored in the secured storage area when the security level is high, the phone book, the certificate, the information about a card, and the information about execution of security can be encrypted and stored in the secured storage area when the security level is medium, and the certificate, the information about a card, and the information about execution of security can be encrypted and stored in the secured storage area when the security level is low.

Although the confidential information depending on the security level may be predetermined by a service provider which provides the preset invention, a user can directly select and set confidential information using a User Interface (UI).

Moreover, the confidential information management module 110 can move the confidential information to the secured storage area, store the confidential information in the secured storage area, and then generate meaningless dummy data and store the dummy data in an initial storage area, that is, a general storage area, in which the confidential information was stored. Further, the confidential information management module 110 can restore the confidential information stored in the secured storage area to the initial storage area in response to a user request. Here, when the confidential information is restored, the confidential information management module 110 can restore the confidential information to encrypted status or decrypted status.

Encryption of the confidential information performed by the confidential information management module 110 may mean encryption of the confidential information itself or encryption of a corresponding area in which the confidential information is stored. In the case of the encryption of the corresponding area, it is preferable to encrypt the corresponding storage area after the confidential information is moved to the secured storage area and stored in the secured storage area.

Further, it is preferable that the confidential information management module 110 determine whether the application which requested the confidential information is a reliable application based on a preset reliable application list, only when the corresponding application is determined as a reliable application, decrypt the confidential information stored in the secured storage area, and supply the decrypted confidential information to the corresponding application.

Here, when the requested confidential information is a single certificate, the confidential information management module 110 may enable multiple applications included in the reliable application list to share the single certificate.

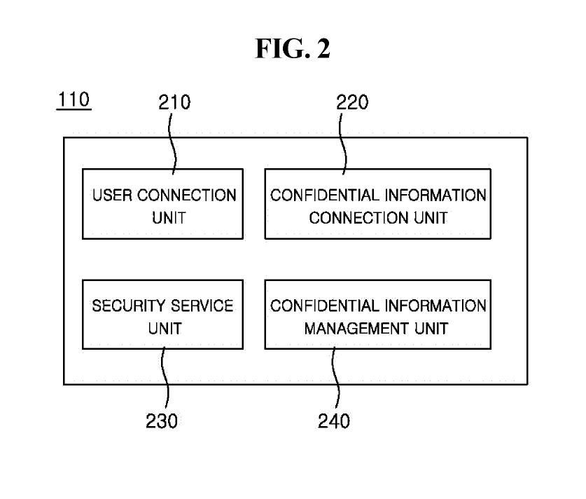

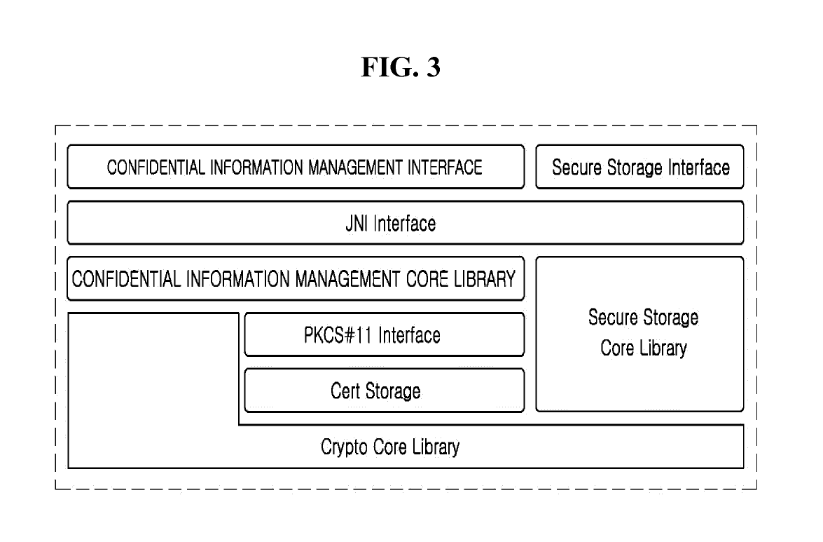

The detailed configuration of the confidential information management module 120 will be described with reference to FIGS. 2 and 3.

FIG. 2 is a view illustrating the configuration of the confidential information management module 110 of FIG. 1 according to the embodiment, and FIG. 3 is a view illustrating the hierarchy structure of the confidential information management module 110 of FIG. 1.

Referring to FIGS. 2 and 3, the confidential information management module 110 includes a user connection unit 210, a confidential information connection unit 220, a security service unit 230, and a confidential information management unit 240.

The user connection unit 210 is an element which connects an application which requested the confidential information or a user with the confidential information management module 110. A confidential information management interface, which is an application program interface used to connect an external input with the confidential information management module, corresponds to the user connection unit 210.

The confidential information connection unit 220 is an element which connects the secured storage area, in which the confidential information is stored, with the confidential information management module 110. A secure storage interface, which is an application program interface used to connect the secured storage area with the confidential information management module, corresponds to the confidential information connection unit 220.

A PKCS#11 interface defines a security service Application Program Interface (API) called a Cryptoki API (CAPI). The PKCS#11 interface corresponds to one of the public key encryption standards provided by RSA, is used to connect the general storage area (Cert Storage) with the confidential information management module, and can be used when the confidential information is stored in the general storage area or when the confidential information stored in the secured storage area is restored to the general storage area.

A Java Native Interface (JNI) is an API formed to access a native code which is executable only on a corresponding platform in a program written in Java, and is preferably located between the user connection unit 210, the confidential information connection unit 220, the security service unit 230, and the confidential information management unit 240.

It is apparent that the present invention is not limited to the JNI, and the corresponding interface may vary depending on a language written for the API.

The security service unit 230 is an element which encrypts confidential information to be stored in the secured storage area under the control of the confidential information management unit 240, and decrypts the encrypted confidential information. A crypto core library corresponds to the security service unit 230.

Here, the security service unit 230 can use a general encryption method, for example, a symmetrical encryption method or an asymmetrical encryption method, when the confidential information is encrypted or decrypted. It is preferable that an authentication value used to generate an encryption key value be a unique value which cannot be known even though the mobile terminal is hacked or illegally copied.

Here, the unique value may include at least one of unique information about the mobile terminal to which the present invention is applied, information which is directly received from a user, and unique information about the confidential information management module.

The confidential information management unit 240 is an element which controls the confidential information management module in general. A confidential information management core library or a secure storage core library corresponds to the confidential information management unit 240.

That is, the confidential information management unit 240 exclusively manages the confidential information and the secured storage area in which the confidential information is stored in order to protect the confidential information stored in the mobile terminal, controls the security service unit 230 so that the confidential information encrypted by the security service unit 230 is stored in the secured storage area, and, when the confidential information stored in the secured storage area is requested through the user connection unit 210, detects the request, accesses the secured storage area, decrypts the requested confidential information using the security service unit 230, and then provides the decrypted confidential information to the user or the corresponding application which requested the confidential information.

Further, when the confidential information is moved from the initially stored area to the secured storage area, the confidential information management unit 240 can remove the confidential information from the general storage area which is the initial storage area so that a possibility that the confidential information may be hacked through the general storage can be reduced, and can generate dummy and store the dummy data in the general storage area data if necessary.

The confidential information management unit 240 assesses the security vulnerability of the mobile terminal. If it is determined that security status is stable based on the results of the assessed security vulnerability, the confidential information management unit 240 stores the confidential information in the secured storage area or provides the confidential information stored in the secured storage area. If the security status is vulnerable, the confidential information management unit 240 provides information indicative of the vulnerable security status to a user.

Here, the confidential information management module 240 can determine the security status of the mobile terminal based on a combination of the attribute of an application, which stores or requests the confidential information, with the security attribute of the mobile terminal itself.

Depending on a situation, the confidential information management unit 240 has an exclusive right to access the secured storage area. In order to prevent access to the secured storage area by an unauthorized person, it is preferable that a user authentication procedure be performed when the secured storage area is accessed.

Here, the user authentication procedure may include an authentication procedure using a user password which is directly set by a user and an authentication procedure using the dedicated password of the confidential information management module.

For example, when the encrypted confidential information is stored in the secured storage area or the confidential information stored in the secured storage area is decrypted and provided to a user, the confidential information management unit 240 receives a user password, used to authenticate the user, from the user, and compares the received user password with a user password which has been preset in order to access the secured storage area. When the two user passwords are identified with each other, the confidential information management unit 240 can move the confidential information to the secured storage area and store the confidential information in the secured storage area, or can decrypt the confidential information using the security service unit 230 and then provide the decrypted confidential information. The confidential information management unit 240 receives the dedicated password of the confidential information management module and determines whether the user authentication procedure is successful or not based on the identification status of the dedicated password. Only when the user authentication procedure is successful, the confidential information management unit 240 can move the confidential information to the secured storage area and store the confidential information in the secured storage area, or can provide the confidential information stored in the secured storage area.

The confidential information management unit 240 further performs functions of determining and selecting a plurality of security levels and confidential information corresponding to each of the security levels, so that confidential information management unit 240 can encrypt the only confidential information corresponding to the selected security levels, move the encrypted confidential information to the secured storage area, and store the encrypted confidential information in the secured storage area. When the confidential information is restored to the general storage area in response to a request by the user, the confidential information management unit 240 also can perform a corresponding function.

Further, when the confidential information encrypted and stored in the secured storage area is requested by an application, it is preferable that the confidential information management unit 240 determine whether the application which requested the confidential information is a reliable application which requires the confidential information, and, in the case of a reliable application, decrypt the confidential information stored in the secured storage area and provide the decrypted confidential information to the corresponding application.

Here, it is preferable that the confidential information management unit 240 include a reliable application list that is a list of reliable applications. Such reliable application list can be provided from a server for setting/managing a reliable application list, can be designated and set based on an application list installed in a terminal in which applications are installed, and can be provided and updated in such a way that the reliable application list is included in update information when at least one application installed in the mobile terminal, information related to the application (for example, a certificate), or information related to the mobile terminal is updated.

Furthermore, when the confidential information includes a single certificate which can be shared by multiple applications, the confidential information management unit 240 can exclusively manage the single certificate and provide the single certificate to at least one of the multiple applications. It is preferable to provide the single certificate only when the application which requested the single certificate is a reliable application which can share the single certificate.

As described above, since the confidential information management module exclusively manages the confidential information and the secured storage area and has a right to exclusive access to the secured storage area, the secured storage area can be accessed only through the confidential information management module. Therefore, when the confidential information stored in the secured storage area is requested, the confidential information management module detects the request, decrypts the corresponding confidential information in the secured storage area, and then provides the decrypted confidential information, so that confidential information which requires security can be protected, thereby improving the security of the confidential information.

Further, since the confidential information is encrypted and stored in the secured storage area, in which data is hidden, using the confidential information management module, the confidential information can be prevented from being exposed to the outside. That is, even if the confidential information is hacked or illegally copied, the confidential information can be prevented from being exposed to the outside.

Further, since a single certificate is exclusively managed using the confidential information management module, the inconvenience of providing certificates for respective applications can be avoided.

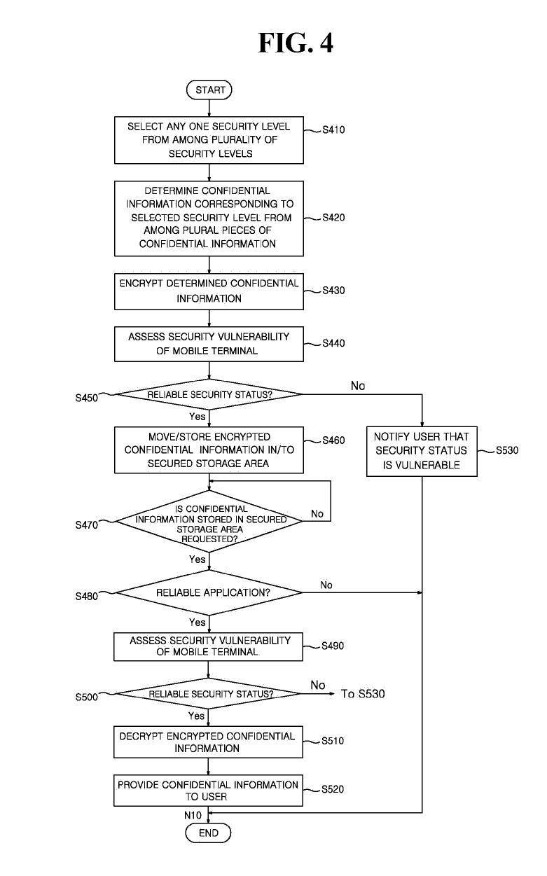

FIG. 4 is a flowchart illustrating the operation of a method for protecting the confidential information of a mobile terminal according to an embodiment of the present invention, that is, a flowchart illustrating the operation performed by the confidential information management module shown in FIG. 1.

Referring to FIG. 4, in the method for protecting confidential information, when any one of a plurality of preset security levels is selected, at least one piece of confidential information corresponding to the selected security level is determined at steps S410 and S420.

Here, the confidential information corresponding to each of the security levels may be directly selected by a user or may be preset when the present invention is applied to a mobile terminal.

When the confidential information is set, the determined confidential information is encrypted using a preset encryption method, and the security vulnerability of the mobile terminal is assessed at step S440.

Here, the security vulnerability of the mobile terminal can be assessed based on the combination of the attribute of an application with the security attribute of the mobile terminal itself.

Here, the confidential information management module can generate an encryption key value, used when the confidential information is encrypted, based on unique information about the mobile terminal, unique information about the confidential information management module, and input information received from the user.

When the security vulnerability is assessed, the confidential information management module determines whether the security status of the mobile terminal is at a reliable level or not based on the results of the assessed security vulnerability at step S450.

If, as a result of the determination at step S450, it is determined that the security status of the mobile terminal is reliable, the confidential information management module moves the encrypted confidential information from an initial storage area, that is, a general storage area, to a secured storage area, and stores the encrypted confidential information in the secured storage area at step S460.

Here, when the encrypted confidential information is copied to the secured storage area, it is preferable that the confidential information stored in the initial storage area be removed. If necessary, dummy data may be generated and stored in the initial storage area from which the confidential information was removed.

Meanwhile, if, as a result of the determination at step S450, it is determined that the security status of the mobile terminal is vulnerable, the confidential information management module notifies a user that the security status is vulnerable at step S530.

Here, various types of methods, including a voice, a message, and an alarm, can be used as a method of notifying the vulnerability of the security status.

If a signal used to request the confidential information is generated by the user or an application which requires the confidential information after the encrypted confidential information is moved to and stored in the secured storage area, the confidential information management module detects the request and determines whether the application which requested the confidential information is a reliable application using a preset reliable application list at steps S470 and S480.

If, as a result of the determination at step S480, it is determined that the application which requested the confidential information is a reliable application, the confidential information management module assesses the security vulnerability of the mobile terminal, and determines whether the security status is reliable or vulnerable based on the result of the assessed security vulnerability of the mobile terminal at steps S490 and S500.

If, as a result of the determination at step S500, it is determined that the security status of the mobile terminal is reliable, the confidential information management module reads and decrypts the confidential information stored in the secured storage area, and provides the decrypted confidential information to the user or the corresponding application which requires the confidential information at steps S510 and S520.

Meanwhile, if, as a result of the determination at step S500, it is determined that the security status of the mobile terminal is vulnerable, the confidential information management module notifies the user that the security status is vulnerable at step S530.

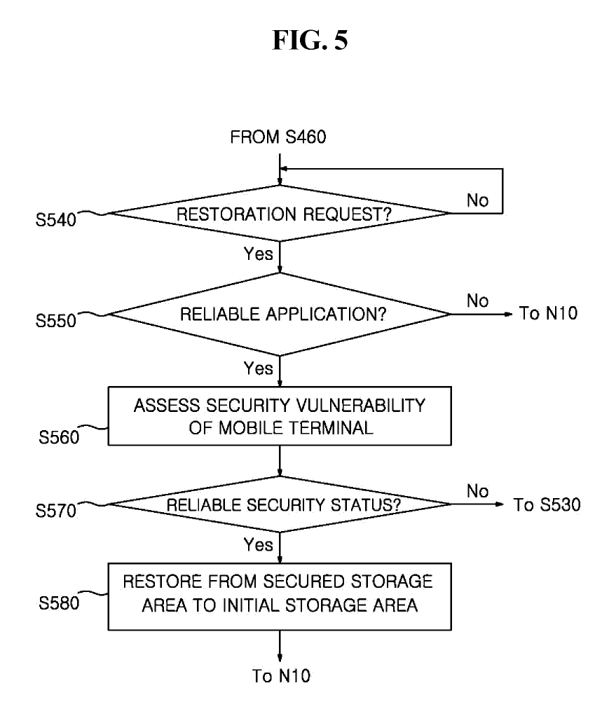

FIG. 5 is a flowchart illustrating an exemplary operation added to the present invention of FIG. 4, that is, a flowchart illustrating an operation when the restoration of confidential information stored in the secured storage area is requested by a user.

Referring to FIG. 5, if the restoration of the confidential information stored in the secured storage area is requested by a user when the encrypted confidential information is moved to and stored in the secured storage area, the confidential information management module detects the request and determines whether an application which requested the restoration of the confidential information is a reliable application using a preset reliable application list at steps S540 and S550.

If, as a result of the determination at step S550, it is determined that the application which requested the confidential information is a reliable application, the confidential information management module assesses the security vulnerability of the mobile terminal, and determines whether the security status is reliable status or vulnerable status based on the result of the assessed security vulnerability of the mobile terminal at steps S560 and S570.

If, as a result of the determination at step S570, it is determined that the security status of the mobile terminal is the reliable status, the confidential information management module decrypts the restoration-requested confidential information stored in the secured storage area, restores the confidential information to the general storage area which is the initial storage area, and removes the restoration-requested confidential information stored in the secured storage area at step S580.

Depending on a situation, the confidential information management module may not remove the restoration-requested confidential information from the secured storage area and maintain the restoration-requested confidential information without change.

Here, when the restoration-requested confidential information is moved to and stored in the secured storage area again, the confidential information management module may extract only updated information from the corresponding confidential information, encrypt the extracted information, and store the encrypted information with the corresponding confidential information in the secured storage area.

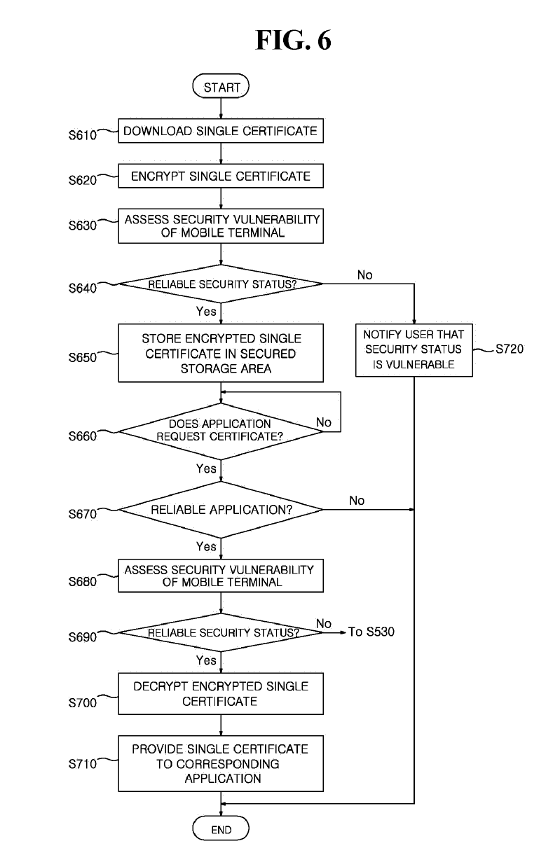

FIG. 6 is a flowchart illustrating a procedure of sharing the single certificate of the confidential information of the mobile terminal according to the present invention, that is, a flowchart illustrating an operation performed by the confidential information management module of FIG. 1.

Referring to FIG. 6, in the procedure of sharing the single certificate, a previously authenticated-single certificate that can be used by multiple applications is downloaded from a certificate issuing server or a system that can issue the single certificate at step S610.

If the single certificate is downloaded, the confidential information management module encrypts the single certificate by applying a preset encryption method, and assesses the security vulnerability of the mobile terminal at step S620 and S630.

Here, the confidential information management module can generate an encryption key value, used when the single certificate is encrypted, based on unique information about a terminal, unique information about the confidential information management module and input information received from a user, and can assess the security vulnerability of the mobile terminal based on the combination of the attributed of an application with the security attribute of the mobile terminal itself.

When the security vulnerability is assessed, the confidential information management module determines whether the security status of the mobile terminal is at a reliable level based on the result of the assessed security vulnerability at step S640.

If, as a result of the determination at step S640, it is determined that the security status of the mobile terminal is reliable, the confidential information management module moves the encrypted single certificate from the initial storage area, that is, the general storage area, to the secured storage area, and stores the encrypted single certificate in the secured storage area at step S650.

When the encrypted single certificate is copied to the secured storage area, it is preferable that the single certificate stored in the initial storage area be removed.

Meanwhile, if, as a result of the determination at step S640, it is determined that the security status of the mobile terminal is vulnerable, the confidential information management module notifies the user that the security status is vulnerable at step S720.

If a request signal, used to request the single certificate, is received from at least one application of the multiple applications installed in the mobile terminal after the encrypted single certificate is stored in the secured storage area, the confidential information management module determines whether the application which requested the single certificate is a reliable application using a preset reliable application list at steps S660 and S670.

If, as a result of the determination at step S670, it is determined that the application which requested the single certificate is a reliable application, the confidential information management module assesses the security vulnerability of the mobile terminal, and determines whether the security status is reliable status or vulnerable status based on the result of the assessed security vulnerability of the mobile terminal at step S680 and S690.

If, as a result of the determination at step S690, it is determined that the security status of the mobile terminal is the reliable status, the confidential information management module reads and decrypts the single certificate stored in the secured storage area, and provides the decrypted single certificate to at least one application which requested the certificate at step S700 and S710.

Although FIGS. 4 to 6 illustrate steps of assessing the security status of a mobile terminal and steps of determining a reliable application, the present invention is not limited thereto, and may additionally include step of performing a user authentication procedure.

Here, the user authentication procedure may be performed using the dedicated password of the confidential information management module as well as using a user password directly set by a user. It is apparent that the user authentication procedure can be performed using both the user password and the dedicated password of the confidential information management module.

Further, although FIGS. 4 to 6 illustrate that steps of assessing the security vulnerability of a mobile terminal and determining security status at steps S490 to S500, S560 to S570, and S680 to S690 are performed after steps of determining a reliable application at steps S480, S550, and S670, the present invention is not limited thereto. Further, steps of determining a reliable application can be performed after steps of assessing the security vulnerability of a mobile terminal and determining security status are performed, and both processes can be performed in parallel.

As described above, according to the present invention, the confidential information management module exclusively manages confidential information, encrypts the confidential information, moves the encrypted confidential information to the secured storage area to which the confidential information management module can exclusively access, and stores the encrypted confidential information in the secured storage area, so that reading of confidential information performed by an unauthorized person and the outflow of confidential information attributable to hacking or illegal copying can be previously prevented, the reading and outflow of the confidential information happening because the confidential information is stored in a unsecured storage area which can be viewed from the outside, thereby improving security of confidential information.

Further, since the present invention can improve security of confidential information in a mobile terminal, the present invention can be applied to all types of mobile terminals that include confidential information, so that profits can be made and security is improved, thereby improving the reliability of all service providers who provide the present invention.

Moreover, according to the present invention, the confidential information management module exclusively manages/sets the secured storage area, thereby improving the stability of the secured storage area. The confidential information management module exclusively manages a single certificate and provides the signal certificate to multiple applications, thereby preventing inconvenience which may happen when a plurality of certificates is managed.

The method for protecting the confidential information of a mobile terminal according to the present invention may be implemented in the form of program instructions which can be executed using various computer means, and may be recorded in computer-readable media. The computer-readable media may include program instructions, a data file, a data structure, or a combination thereof. The program instructions recorded in the media may be program instructions that are specially designed and constructed for the present invention or that are well known to and used by those skilled in the field of computer software. Examples of the computer-readable media includes magnetic media such as a hard disk, a floppy disk and a magnetic tape, optical media such as CD-ROM and a DVD, magneto-optical media such as a floptical disk, and hardware devices specially configured to store and execute program instructions, such as ROM, RAM and flash memory. Examples of the program instructions include not only machine language code compiled by a compiler but also high-level language code executed by a computer through an interpreter. The above-described hardware device may be configured to operate in the form of at least one software module in order to perform the operation of the present invention, and vice versa.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for protecting confidential information of a mobile terminal, comprising:
a storage unit configured to store at least one piece of confidential information which requires security; and
a confidential information management unit configured to:
move the confidential information from a preset initial unsecured storage area of the storage unit, to a preset secured storage area of the storage unit, and
to store the confidential data in the preset secured storage area, in order to protect the confidential data, and exclusively managing the secured storage area;
wherein the secured storage area is set by the confidential information management unit.

2. The apparatus of claim 1, wherein the confidential information management unit is configured to set a part of a memory area in which the confidential information management unit is executed, as the secured storage area.

3. The apparatus of claim 1, wherein the confidential information management unit is configured to set a part of a storage area of a smart card, which includes a Universal Subscriber Identity Module (USIM) card, or a part of a storage area of an external database, which is in conjunction with the mobile terminal, as the secured storage area.

4. The apparatus of claim 1, wherein the confidential information management unit is configured to set a preset virtual storage space as the secured storage area.

5. The apparatus of claim 1, wherein the confidential information management unit is configured to identify confidential information corresponding to each of a plurality of preset security levels, and, when any one of the security levels is selected from among the plurality of security levels is identified, move the confidential information corresponding to the selected security level to the secured storage area, and store the corresponding confidential information in the secured storage.

6. The apparatus of claim 1, wherein the confidential information management unit is configured to generate dummy data and then store the dummy data in the initial storage area, after moving the confidential information to the secured storage area.

7. The apparatus of claim 1, wherein the confidential information management unit is configured to perform user authentication to access the secured storage area, and, when the user authentication is successful, move the confidential information to the secured storage area and store the confidential information in the secured storage area, or provide the confidential information stored in the secured storage area to the user.

8. The apparatus of claim 1, wherein the confidential information management unit is configured to restore the confidential information stored in the secured storage area to the initial storage area in response to a user request.

9. The apparatus of claim 1, wherein the confidential information management unit comprises a preset reliable application list, and, when an application which requested the confidential information is an application included in the reliable application list, provides the confidential information to the application which requested the confidential information.

10. The apparatus of claim 1, wherein the confidential information comprises personal confidential information, including a phone book, an address book, a call log, a transmitted or received message, a photo, a video, a certificate and information about a card, and at least one piece of authentication information or a key value, which is used to access at least a part of the confidential information.

11. The apparatus of claim 1, wherein:
the confidential information comprises a single certificate which is able to be shared by preset multiple applications; and
the confidential information management unit provides the single certificate to at least one application of the multiple applications when the single certificate is requested by the at least one application.

12. The apparatus of claim 1, further comprising a security service unit configured to encrypt the confidential information and decrypt the encrypted confidential information in the secured storage area under control of the confidential information management unit;
wherein the security service unit encrypts the confidential information itself or encrypts a storage area in which the confidential information to be stored.

13. The apparatus of claim 12, wherein the security service unit either encrypts or decrypts the confidential information based on at least one selected from a group consisting of unique information about the mobile terminal, unique information about the confidential information management unit, and information which was previously input by a user.

14. A method for protecting confidential information of a mobile terminal, comprising:
setting, by a storage unit, a secured storage area in which stored data is hidden;
moving, by a confidential information management unit, the confidential information from a preset initial unsecured storage area, to the set secured storage area;
storing, by the confidential information management unit, the confidential information in the set secured storage area, in order to protect at least one piece of confidential information which requires security; and
in response to confidential information being requested, accessing, by the confidential information unit, the secured storage area and providing the confidential information through exclusive management of the secured storage area.

15. The method of claim 14, wherein setting further comprises setting at least one of a part of a memory area in which the confidential information management unit for exclusively managing the secured storage area is executed, a part of a storage area of a smart card which includes a USIM card, a part of a storage area of an external database which is in conjunction with the mobile terminal, and a preset virtual storage space as the secured storage area.

16. The method of claim 14, further comprising determining confidential information corresponding to each of a plurality of preset security levels;
wherein storing further comprises moving only confidential information, which corresponds to a security level selected from among a plurality of security levels, to the secured storage area and storing the corresponding confidential information in the secured storage.

17. The method of claim 14, further comprising generating dummy data and then storing the dummy data in the initial storage area, after moving the confidential information to the secured storage area.

18. The method of claim 14, further comprising restoring the confidential information stored in the secured storage area to the initial storage area in response to a user request.

19. The method of claim 14, wherein providing further comprises:
determining whether an application which requested the confidential information is included in a reliable application list; and
providing the confidential information to the application which requested the confidential information when the application which requested the confidential information is included in the reliable application list.

20. A computer readable recording medium containing executable program instructions executed by a processor, comprising:
program instructions that set a secured storage area in which stored data is hidden;
program instructions that move the confidential information from a preset unsecured initial storage area, to the set secured storage area and store the confidential information in the set secured storage area, in order to protect at least one piece of confidential information which requires security; and
program instructions that access the secured storage area and provide the confidential information through exclusive management of the secured storage area when the confidential information is requested.
